(19) United States
(12) Patent Application Publication
(10) Pub. No.: US 2018/0214248 A1
(43) Pub. Date: Aug. 2, 2018

(54) THROAT DAM SUCTION DEVICE AND METHODS OF USE

(71) Applicant: Arlene MESSER, Pittsford, NY (US)

(72) Inventor: Arlene MESSER, Pittsford, NY (US)

(21) Appl. No.: 15/834,795

(22) Filed: Dec. 7, 2017

Related U.S. Application Data
(60) Provisional application No. 62/452,022, filed on Jan. 30, 2017.

(51) Int. Cl. A61C 5/90; A61C 17/06

(52) U.S. Cl. CPC A61C 5/90; A61C 17/04

(57) ABSTRACT

A dental device and method for use in the dental device are disclosed. The dental device includes a frame with an interior tube, at least one aperture extending from an exterior surface of the frame into the interior tube, and a mesh material coupled to an interior surface of the frame. A method of using the dental device is also disclosed.

### CROSS REFERENCE TO RELATED APPLICATION

This application claims priority benefit under 35 U.S.C. § 119(e) of U.S. provisional patent application No. 62/452,022 filed Jan. 30, 2017, which is incorporated herein by reference in its entirety.

### FIELD OF THE INVENTION

The present disclosure relates generally to dental devices. More specifically, but not exclusively, the present disclosure relates to a dental device for preventing foreign objects from entering a patients throat and suctioning saliva during a dental procedure.

### BACKGROUND OF THE INVENTION

During dental procedures foreign objects may be dropped in a patient's mouth. In order to prevent the patient from choking if a foreign object is dropped, a device is needed to cover the patient's throat, while not interfering with the patient's breathing.

### SUMMARY OF THE INVENTION

Aspects of the present disclosure provide a dental device for use during dental procedures and a method of using the dental device.

In one aspect, provided herein is a dental device that includes a frame with an interior tube, at least one aperture extending from an exterior surface of the frame into the interior tube, and a mesh material coupled to an interior surface of the frame.

In another aspect, provided herein is a method for using a dental device that includes obtaining a dental device and inserting the dental device into a patient's mouth. The method also includes positioning the dental device in the patient's mouth and performing the dental procedure. In addition, the method includes removing the dental device from a patient's mouth.

These, and other objects, features and advantages of this disclosure will become apparent from the following detailed description of the various aspects of the disclosure taken in conjunction with the accompanying drawings.

### BRIEF DESCRIPTION OF DRAWINGS

The accompanying drawings, which are incorporated in and constitute a part of the specification, illustrate embodiments of the disclosure and together with the detailed description herein, serve to explain the principles of the disclosure. The drawings are only for purposes of illustrating preferred embodiments and are not to be construed as limiting the disclosure. It is emphasized that, in accordance with the standard practice in the industry, various features are not drawn to scale. In fact, the dimensions of the various features may be arbitrarily increased or reduced for clarity of discussion. The foregoing and other objects, features and advantages of the disclosure are apparent from the following detailed description taken in conjunction with the accompanying drawings in which:

FIG. 1 is a top perspective view of one embodiment of a dental device, in accordance with an aspect of the present disclosure;

FIG. 2 is a top view of the dental device of FIG. 1, in accordance with an aspect of the present disclosure;

FIG. 3 is a bottom view of the dental device of FIG. 1, in accordance with an aspect of the present disclosure;

FIG. 4 is a first side view of the dental device of FIG. 1, in accordance with an aspect of the present disclosure;

FIG. 5 is a second side view of the dental device of FIG. 1, in accordance with an aspect of the present disclosure;

FIG. 6 is a first end view of the dental device of FIG. 1, in accordance with an aspect of the present disclosure;

FIG. 7 is a second end view of the dental device of FIG. 1, in accordance with an aspect of the present disclosure; and

FIG. 8 is a cross-sectional view of a portion of the dental device of FIG. 2, in accordance with an aspect of the present disclosure.

### DETAILED DESCRIPTION FOR CARRYING OUT THE INVENTION

Generally stated, disclosed herein is one embodiment of a dental device. Further, a method for using the dental device is discussed.

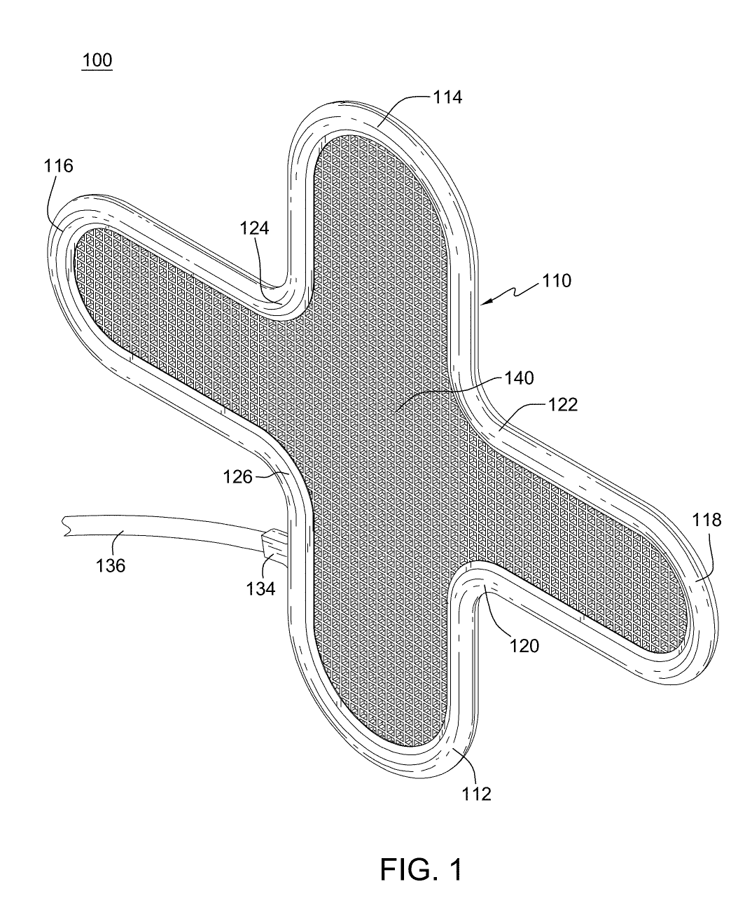

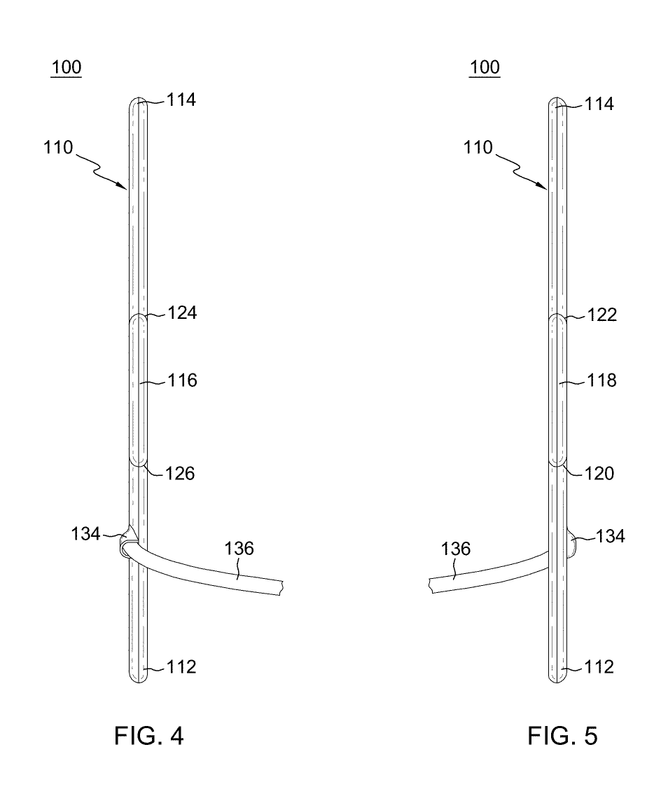

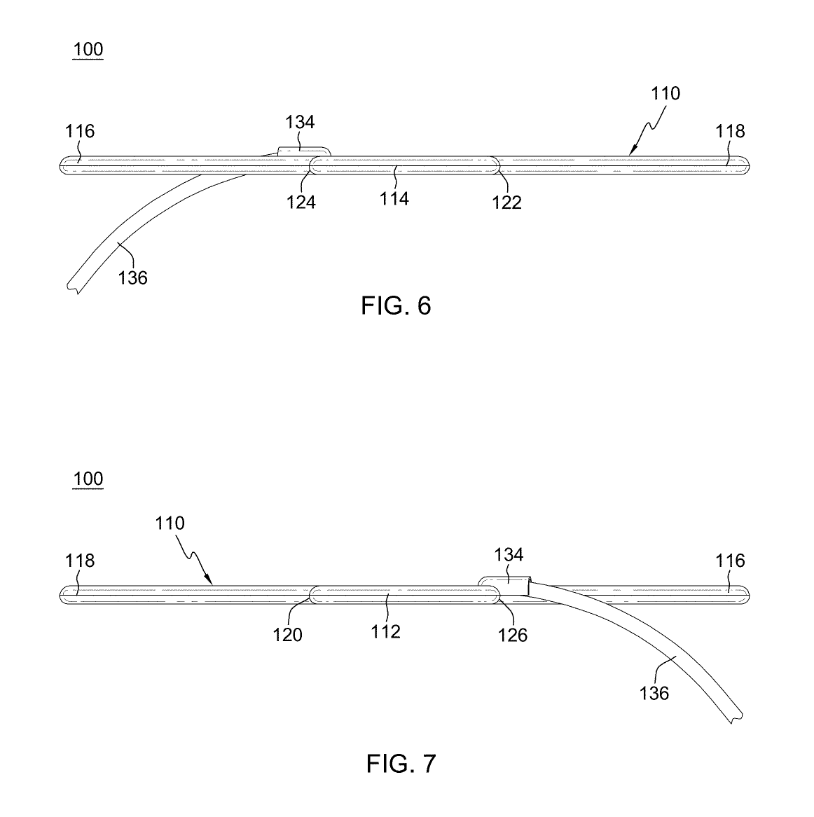

Referring to the drawings, wherein like reference numerals are used to indicate like or analogous components throughout the several views, and with particular reference to FIGS. 1-8, there is illustrated a dental device 100. The dental device 100 may include a frame 110, a suction tube coupling mechanism 134 coupled to the frame 110, and a mesh member 140 coupled to the frame 110. The frame 110 may be, for example, a single tube curved to form the dental device 100. Alternatively, the frame 110 may be, for example, at least two pieces of deformable material secured together to form a curved tube. In one embodiment, the at least two pieces are, for example, at least one top member and at least one bottom member. In yet another embodiment, the at least two pieces are, for example, tube portions positioned adjacent to each other. The frame 110 may be made of, for example, a deformable material that may be formed into a tube having an opening 130 extending through the middle of the tube. The frame 110 may have, for example, a “t” or cross shape. The dental devices 100 may be sized to correspond to the size of the patient's mouths.

The frame 110 may be shaped to include four extension members 112, 114, 116, 118. As shown in FIGS. 1-3, the frame 110 may include, for example, a first or bottom extension member 112 and a second or top extension member 114. The first extension member 112 may be positioned directly opposite the second extension member 114. The frame 110 may also include, for example, a third or first lateral extension member 116 and a fourth or second lateral extension member 118. The third extension member 116 may be positioned directly opposite the fourth extension member 118. The extension members 112, 114, 116, 118 may each have, for example, a curved end surface. The extension members 112, 114, 116, 118 may have, for example, a “U” shaped or “n” shaped member.

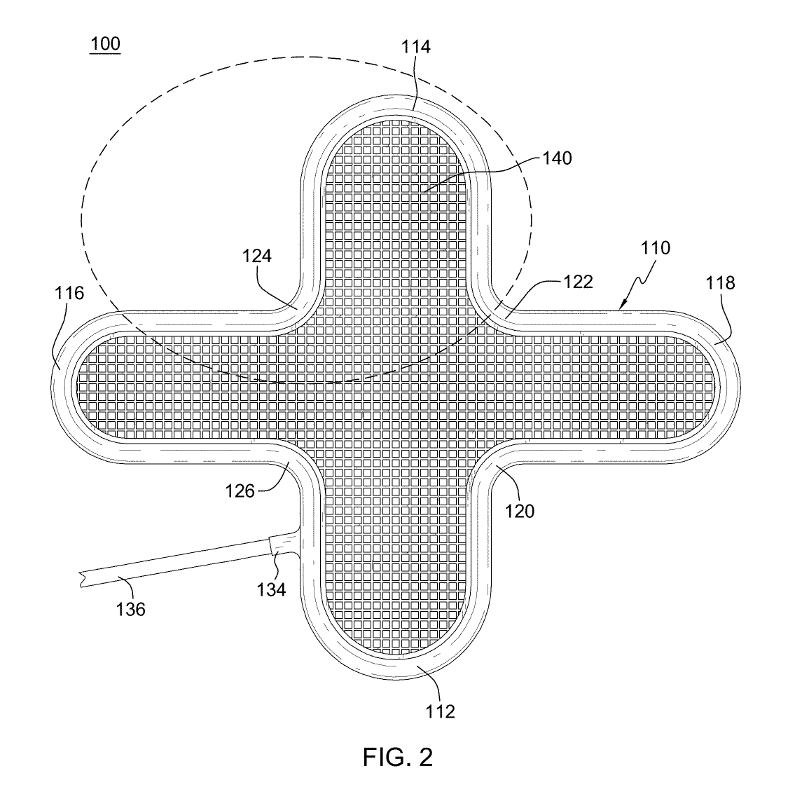

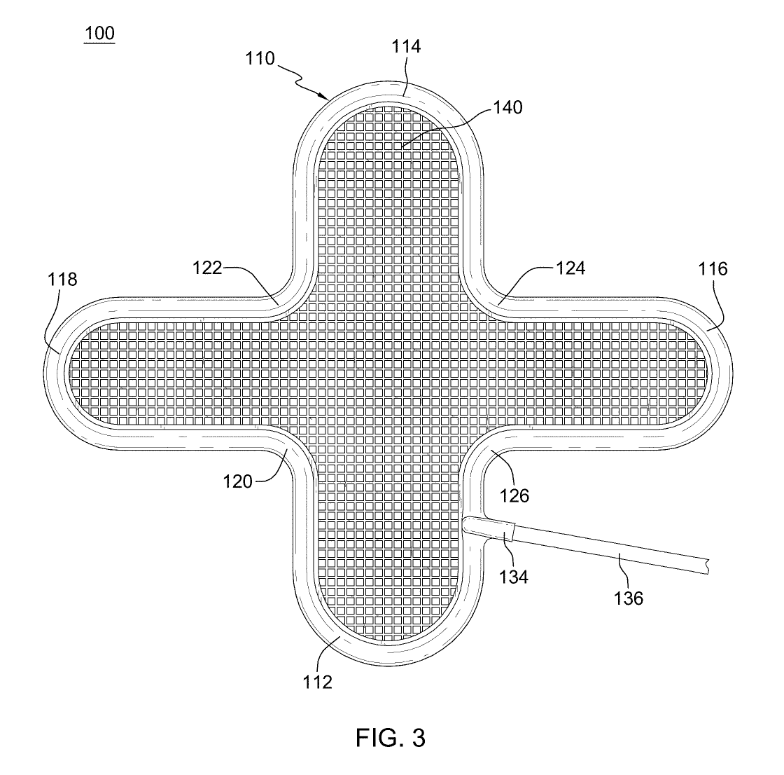

With continued reference to FIGS. 2 and 3, the extension members 112, 114 may have a first width, the measurement between the two parallel sides of the frame 110 of the extension members 112, 114. The extension members 112, 114 may also include a first length, the measurement between the adjacent extension members 116, 118 and the curved end of the extension members 112, 114. The extension members 116, 118 may have a second width, the measurement between the two parallel sides of the frame 110 of the extension members 116, 118. The extension members 116, 118 may also include a second length, the measurement between the adjacent extension members 112, 114 and the curved end of the extension members 116, 118. In one embodiment, the first width may be larger than the second width and the second length may be larger than the first length.

With continued reference to FIGS. 1-3, the shaped frame 110 may also include four corner or connector members 120, 122, 124, 126. The connector members 120, 122, 124, 126 may be positioned between and connected to each of the extension members 112, 114, 116, 118. For example, the first connector 120 couples the first extension member 112 and the fourth extension member 118. The second connector 122 couples the fourth extension member 118 and the second connector member 114. The third connector 124 couples the second connector member 114 and the third connector member 116. The fourth connector 126 couples the third connector member 116 and the first connector member 112.

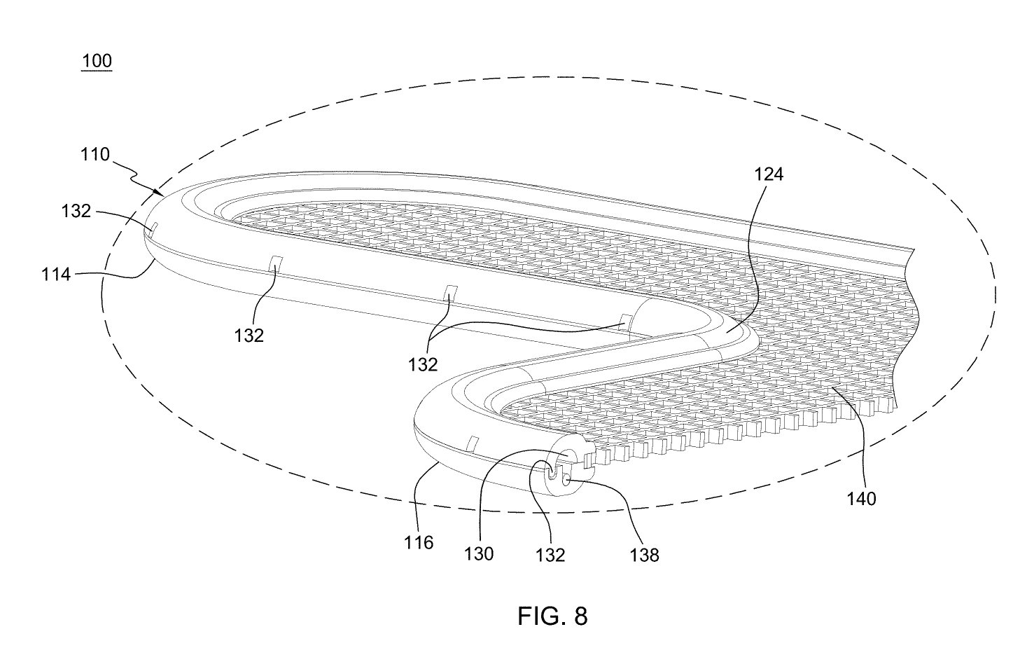

Referring now to FIG. 8, the interior tube or opening 130 may include a curved or hemispherically shaped opening in the top portion of the tube 130 and a channel in the bottom portion of the tube 130. The channel may be, for example, narrower than the hemispherical shaped portion. The channel may be sized and shaped to receive a wire or member 138. The wire 138 may extend in the channel around the entire frame 110. The wire 138 may be, for example, deformable or resilient to take on the shape of the frame 110. The wire 138 may be made of a resilient material that enables the dental device 100 to hold a patient's mouth open. The wire 138 may be shaped to fit within a patient's mouth.

The frame 110 may also include a plurality of apertures, holes or openings 132, as shown in FIG. 8. The plurality of apertures 132 extend from an exterior surface of the frame 110 into the interior tube 130. For example, the plurality of apertures 132 may be positioned in the top portion of the frame 110 and extend into the hemispherical shaped portion of the tube 130. In one embodiment, the plurality of apertures 132 may be positioned to correspond to the placement of salivary glands in a patient's mouth. The plurality of apertures 132 may be increased or reduced to provide the desired evacuation of fluids from a patient's mouth during a dental procedure.

The suction tube coupling, suction coupling mechanism, or evacuation port 134 may be positioned on the frame 110, as shown in FIGS. 1-7. The suction tube coupling 134 connects the suction tubing 136 to the interior tube 130 to enable fluid to travel through the frame 110 to the suction tubing 136. The suction tubing 136 may be coupled to a standard dental suction machine at the second end. The dental device 100 may allow for manual suction and/or continual suction during a dental procedure.

As shown in FIGS. 1-3 and 8, the mesh member 140 may be stretched between and coupled to an interior portion or interior surface of the frame 110. The mesh member 140 may be secured in a groove or channel 142 positioned between a top portion and a bottom portion of the frame 110. The groove 142 may be inset into the exterior surface of the frame 110 on an interior side of the frame. The mesh member 140 may be made of, for example, a dental screen material or any material that provides coverage of the tonsillar pillars to prevent dental materials from passing into the patient's throat.

A method for using the dental device 100 includes bending or curving the dental device 100 to a size appropriate for insertion into a patient's mouth. The method may also include inserting the dental device 100 into the patient's mouth and positioning the dental device 100 in the bony areas of the patient's mouth. Once the dental device 100 is positioned in the patient's mouth, the dental device 100 may be released and the extension members 112, 114 may contact the roof of the patient's mouth and the patient's tongue. In addition, the extension members 116, 118 may extend between the patient's teeth and at least partially contact the inside of the patient's cheeks. If the frame 110 does not fit well within the patient's mouth, the dental professional may either replace the dental device 100 with a different sized dental device 100 or the dental professional may bend the extension members 112, 114, 116, 118 to the desired fit within the patient's mouth. After the dental device 100 is positioned in the patient's mouth, the suction may be turned on to remove fluids in the patient's mouth during the dental procedure. After the dental procedure is complete, the suction device may be turned off and the dental device 100 may be removed from the patient's mouth. The dental device 100 may be used on any patient, including patients without teeth as the dental device 100 is not coupled to a patient's teeth.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

Having thus described the preferred embodiments, the disclosure is now claimed to be:

1. A dental device, comprising:
a frame with an interior tube;
at least one aperture extending from an exterior surface of the frame into the interior tube; and
a mesh material coupled to an interior surface of the frame.

2. The dental device of claim 1, wherein the frame comprises:
a first extension member; and
a second extension member positioned opposite the first extension member.

3. The dental device of claim 2, wherein the frame comprises:
a third extension member positioned between the first extension member and the second extension member;
a fourth extension member positioned between the first extension member and the second extension member and wherein the fourth extension member is positioned opposite the third extension member.

4. The dental device of claim 3, further comprising:
a first corner member positioned between the first extension member and the fourth extension member;
a second corner member positioned between the fourth extension member and the second extension member;
a third corner member positioned between the second extension member and the third extension member; and
a fourth corner member positioned between the third extension member and the first extension member.

5. The dental device of claim 4, wherein the first extension member is positioned opposite the second extension member, and the first and second extension members have a first width.

6. The dental device of claim 5, wherein the third extension member is positioned opposite the fourth extension member, and the third and fourth extension members have a second width.

7. The dental device of claim 6, wherein the second width is smaller than the first width.

8. The dental device of claim 1, wherein the frame further comprises:
a top portion; and
a bottom portion coupled to the top portion.

9. The dental device of claim 8, wherein the top portion includes an interior channel.

10. The dental device of claim 9, wherein the interior channel is hemispherically shaped.

11. The dental device of claim 8, wherein the bottom portion includes a channel.

12. The dental device of claim 1, wherein the frame further comprises:
a suction coupling mechanism coupled to the frame.

13. The dental device of claim 11, further comprising:
a wire positioned in the channel and extending parallel to the frame.

14. The dental device of claim 1, further comprising:
a groove extending around an interior surface of the frame, wherein the groove is sized and shaped to receive the mesh material.

15. The dental device of claim 1, wherein the frame is cross shaped.

16. The dental device of claim 3, wherein the wherein the extension members are U shaped.

17. The dental device of claim 1, wherein the frame comprises a single tube.

18. A method, comprising:
obtaining a dental device;
inserting the dental device into a patient's mouth;
positioning the dental device in the patient's mouth;
performing a dental procedure; and
removing the dental device from the patient's mouth.

19. The method of claim 18, wherein the dental device comprises:
a frame with an interior tube;
at least one aperture extending from an exterior surface of the frame into the interior tube; and
a mesh material coupled to an interior surface of the frame.

20. The method of claim 19, wherein the dental device further comprises:
a first extension member;
a second extension member positioned opposite the first extension member;
a third extension member positioned between the first extension member and the second extension member;
a fourth extension member positioned between the first extension member and the second extension member and wherein the fourth extension member is positioned opposite the third extension member;
a first corner member positioned between the first extension member and the fourth extension member;
a second corner member positioned between the fourth extension member and the second extension member;
a third corner member positioned between the second extension member and the third extension member; and
a fourth corner member positioned between the third extension member and the first extension member.
